(19) United States
(12) Patent Application Publication
(10) Pub. No.: US 2025/0115464 A1
(43) Pub. Date: Apr. 10, 2025

(54) SINGLE-PIECE AND MULTIPLE-PIECE PRY BAR

(71) Applicant: Gary Sandusky, Riverside, CA (US)

(72) Inventor: Gary Sandusky, Riverside, CA (US)

(21) Appl. No.: 18/906,523

(22) Filed: Oct. 4, 2024

Related U.S. Application Data
(60) Provisional application No. 63/587,843, filed on Oct. 4, 2023.

(51) Int. Cl. B66F 15/00

(52) U.S. Cl. CPC B66F 15/00

(57) ABSTRACT

A single-piece and multi-piece pry bar is disclosed. The single-piece pry bar may be compact enough to fit in tight places and have a handle opening to protect the hand of the user when prying objects. The multi-piece pry bar may also have a handle opening to protect the hand of the user and additionally have different extension components that may be attached to the rear portion of the multi-piece pry bar. The different extension components may, for example, be a handle extension that has a second handle opening and adds length to the multi-piece pry bar to increase the leverage the user may apply. The handle openings of the multi-piece pry bar may have different dimensions and orientations to allow the user to better grip the pry bar.

### CROSS-REFERENCE TO RELATED APPLICATIONS

This application claims priority to Prov. Pat. App. Ser. No. 63/587,843, filed on 2023 Oct. 4, the entire contents of which are expressly incorporated herein by reference.

### STATEMENT RE: FEDERALLY SPONSORED RESEARCH/DEVELOPMENT

Not Applicable

### BACKGROUND

The various aspects and embodiments described herein relate to a single-piece and multi-piece pry bar and a method of using thereof.

Conventional pry bars may be used for demolition, disassembling, and prying open objects. However, conventional pry bars have certain deficiencies that do not allow the user to effectively use the pry bar.

Accordingly, there is a need in the art for an improved device, system, and method for utilizing a pry bar.

### BRIEF SUMMARY

The various embodiments and aspects disclosed herein address the needs discussed above, discussed below and those that are known in the art.

A single-piece and multi-piece pry bar is disclosed. The single-piece pry bar may be compact enough to fit in tight places and have a handle opening to protect the hand of the user when prying objects. Different components such as an L-shaped bracket and a hammer head may be attached to the single-piece pry bar for increased leverage and additional functionality. The multi-piece pry bar may also have a handle opening to protect the hands of the user and additionally have different extension components that may be attached to the rear portion of the multi-piece pry bar. The different extension components may, for example, be a handle extension that has a second handle opening and adds length to the multi-piece pry bar to increase the leverage the user may apply. The handle openings of the multi-piece pry bar may have different dimensions and orientations to allow the user to better grip the pry bar. For example, each of the handle openings of the multi-piece pry bar may be big enough for both hands of the user to grip around them and be inclined to create a change in thickness profile that provides for better gripping. Other types of extension components, such as an axe head extension or a wrench head extension, that add additional functionality to the multi-piece pry bar may also be attached to the multi-piece pry bar. The multi-piece pry bar may be stored in a smaller space than if the pry bar was a single piece since the extension components may be removably attachable to the main body of the pry bar.

More particularly, a multi-piece pry bar is disclosed. The multi-piece pry bar may have a singular pry bar piece having a shaft connected to a claw section. The shaft may have a shaft body with a top side, a bottom side opposite to the top side, a front shaft end connected to the claw section, a rear shaft portion with an interlocking mechanism, and a first handle opening extending longitudinally in between the front shaft end and the rear shaft portion. The claw section may have a curved body with a rear planar segment connected to the front shaft end, a front planar segment having a prying edge, and a curved segment between the rear planar segment and the front planar segment, the curved segment having an outer curved surface making up a heel of the claw section, the heel being on a same side as the bottom side of the shaft body. The multi-piece pry bar may have a handle extension piece removably attachable to the rear shaft portion of the singular pry bar piece via the interlocking mechanism. The handle extension piece may have an extension body with an upper side that connects with the top side of the shaft body, a lower side that connects with the bottom side of the shaft body, a front extension end configured to be attached to the rear shaft portion, a rear extension portion, and a second handle opening extending longitudinally in between the front extension end and the rear extension portion.

In some embodiments, the prying edge of the claw section may have a V-shaped groove. In some embodiments, the front planar segment of the claw section may have a keyhole slot.

In some embodiments, the shaft may have a first width and the claw section may have a second width, the second width being at least 1.5 times greater than the first width.

In some embodiments, the first handle opening and the second handle opening are each large enough to be gripped by two hands.

In some embodiments, the multi-piece pry bar may have at least one of a hammer extension piece, an axe extension piece, or a wrench extension piece that are removably attachable to the rear shaft portion of the singular pry bar piece via the interlocking mechanism.

In some embodiments, the interlocking mechanism may be a detent mechanism.

In some embodiments, the first handle opening may have a first longitudinal length between a first side near the claw section and a second side near the rear shaft portion, the first longitudinal length inclining downwards from the first side towards the second side. In some embodiments, the second handle opening may have a second longitudinal length between a third side near the front extension end and a fourth side near the rear extension portion, the second longitudinal length inclining downwards from the third side towards the fourth side.

In some embodiments, the first handle opening may have a first longitudinal length between a first side near the claw section and a second side near the rear shaft portion, the first longitudinal length inclining upwards from the first side towards the second side. In some embodiments, the second handle opening may have a second longitudinal length between a third side near the front extension end and a fourth side near the rear extension portion, the second longitudinal length inclining upwards from the third side towards the fourth side.

In some embodiments, the first and second handle openings may each have a plurality of finger gripping grooves.

In some embodiments, the first and second handle opening may be trapezoidal shaped.

In some embodiments, the multi-piece pry bar may have a tying hole near the rear extension portion of the handle extension piece.

Furthermore, a pry bar is disclosed. The pry bar may have a shaft having a shaft body with a top side, a bottom side opposite to the top side, a front shaft end, a rear shaft portion, and a first handle opening extending longitudinally in between the front shaft end and the rear shaft portion, and a claw section having a curved body with a rear planar segment connected to the front shaft end, a front planar segment having a prying edge, and a curved segment between the rear planar segment and the front planar segment, the curved segment having an outer curved surface making up a heel of the claw section, the heel being on a same side as the bottom side of the shaft body.

In some embodiments, an L-shaped bracket may be attachable to the top side of the shaft.

In some embodiments, an L-shaped bracket may be integrated to the top side of the shaft.

In some embodiments, a portion of the bottom side of the shaft near the front shaft end may have a threaded hole for a hammer head to be attached to the pry bar.

In some embodiments, the first handle opening may only be large enough to be gripped by one hand.

In some embodiments, the shaft may have a tying hole proximate to the rear shaft portion.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A shows a perspective view of an embodiment of a pry bar that is one-piece;

FIG. 1B shows a side view of the one-piece pry bar;

FIG. 2A shows a front view of the claw section of the pry bar;

FIG. 2B shows a top view of the claw section of the pry bar;

FIG. 2C shows a bottom view of the claw section of the pry bar;

FIG. 2D shows a side view of the claw section of the pry bar;

FIG. 3A shows a perspective view of another embodiment of the pry bar that has multiple pieces;

FIG. 3B shows a top view of the multiple-piece pry bar;

FIG. 3C shows a first side view of the multiple-piece pry bar;

FIG. 3D shows a second side view of the multiple-piece pry bar;

FIG. 4A shows a first side view of the multiple-piece pry bar with a handle extension;

FIG. 4B shows a second side view of the multiple-piece pry bar with the handle extension;

FIG. 5A shows a side view of the multiple-piece pry bar with the handle openings at a first incline;

FIG. 5B shows a side view of the multiple-piece pry bar with the handle openings at a second incline;

FIG. 5C shows a side view of the multiple-piece pry bar with the handle openings having a first trapezoidal shape;

FIG. 5D shows a side view of the multiple-piece pry bar with the handle openings having a second trapezoidal shape;

FIG. 5E shows a side view of the multiple-piece pry bar with each of the handle openings having a set of gripping grooves;

FIG. 5F shows a side view of the multiple-piece pry bar with each of the handle openings having two sets of gripping grooves

FIG. 6A shows a side view of the one-piece pry bar having an integrated L-shaped bracket;

FIG. 6B shows a side view of the one-piece pry bar having a detachable L-shaped bracket;

FIG. 7A shows a close-up side view of the claw section and the front shaft end with a hammer head;

FIG. 7B shows a close-up bottom view of the claw section and the front shaft end with a threaded hole for different components to be attached;

FIG. 8A shows a side view of the multiple-piece pry bar with an axe head extension;

FIG. 8B shows a side view of the multiple-piece pry bar with a sledgehammer head extension;

FIG. 8C shows a side view of the multiple-piece pry bar with a wrench head extension;

FIG. 9 shows an exploded perspective view of the multi-piece pry bar with a removable claw section;

FIG. 10 shows an exploded view of the multi-piece pry bar with a connecting sleeve for attaching two shafts together;

FIG. 11 shows a cross-sectional view of the multi-piece pry bar with the connecting sleeve attaching two shafts shown in FIG. 10; and

FIG. 12 shows a cross-sectional view of the multi-piece pry bar with the connecting sleeve shown in FIG. 10 fully securing two shafts together.

### DETAILED DESCRIPTION

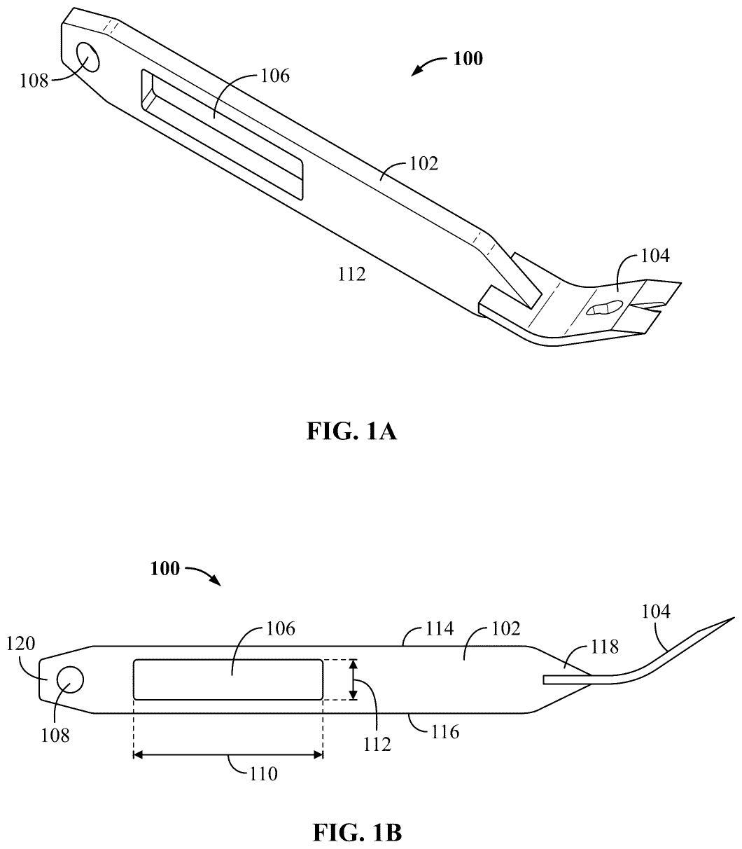

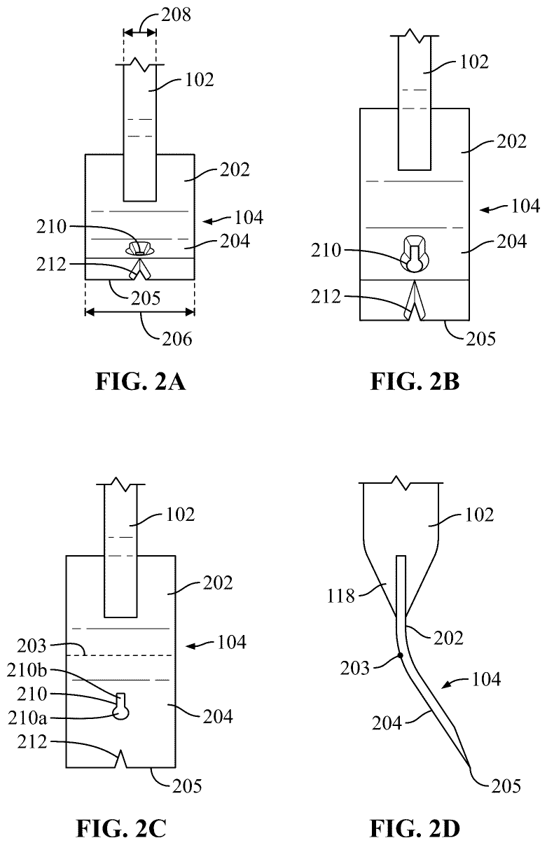

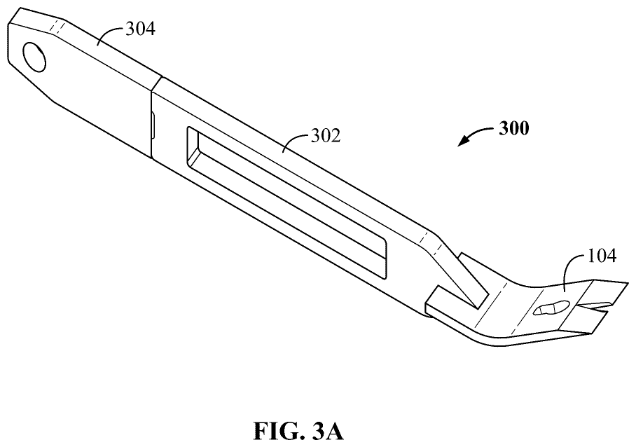

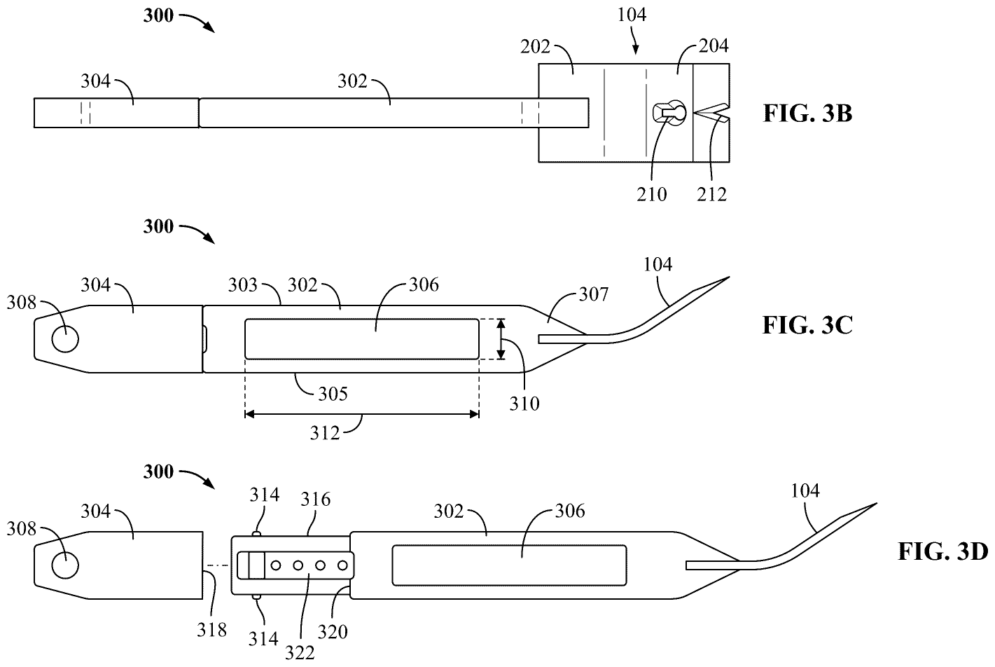

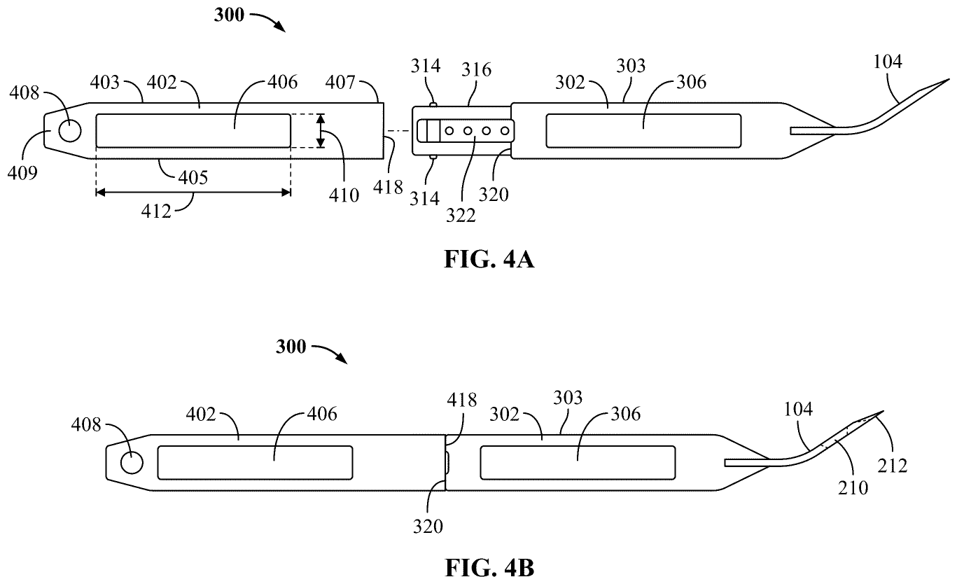

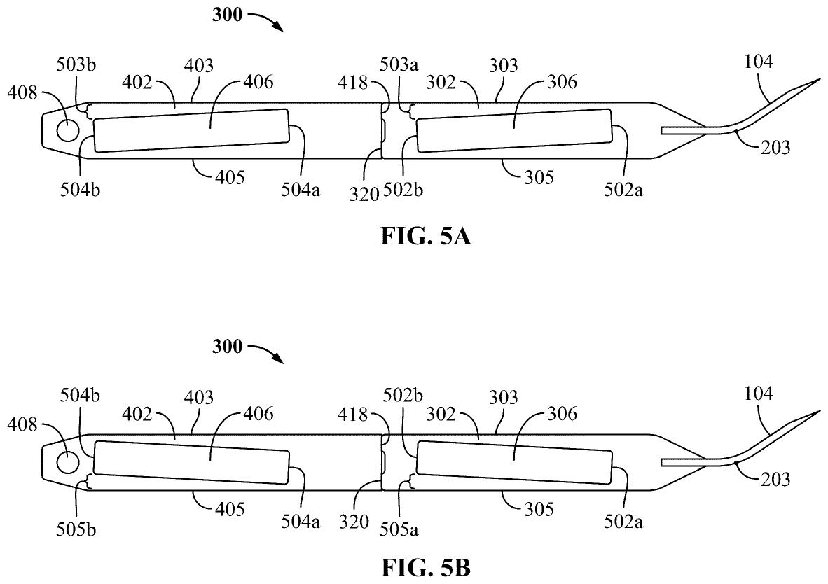

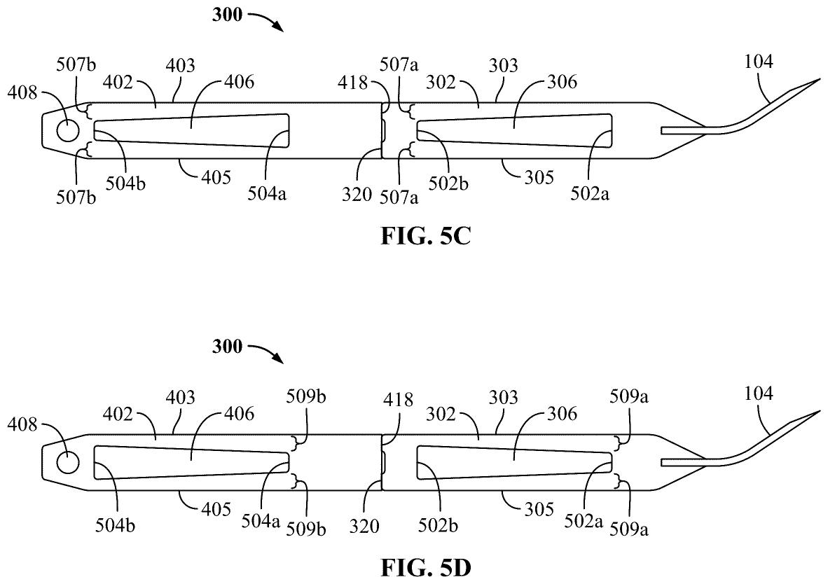

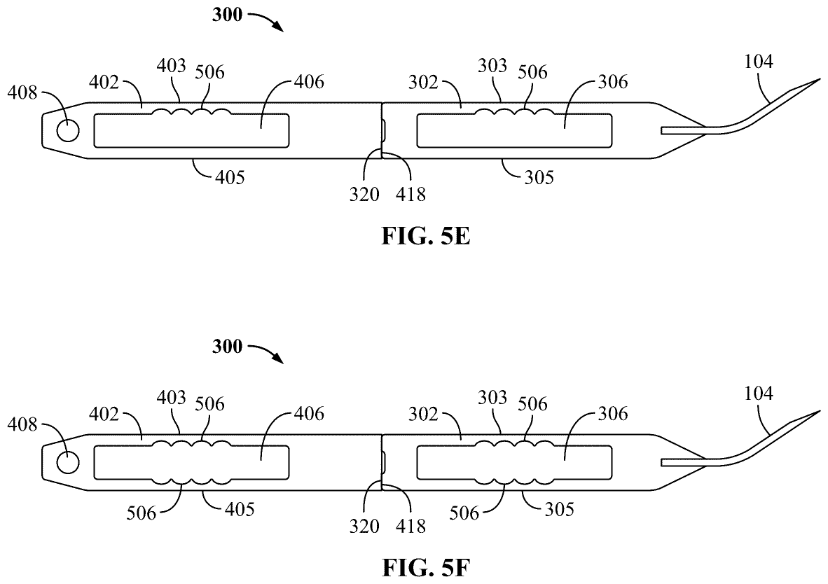

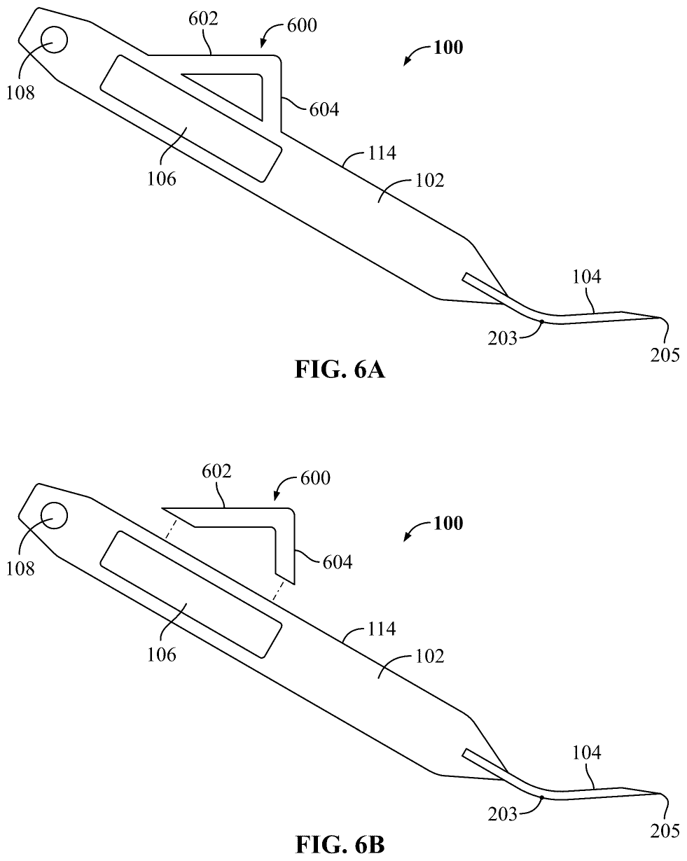

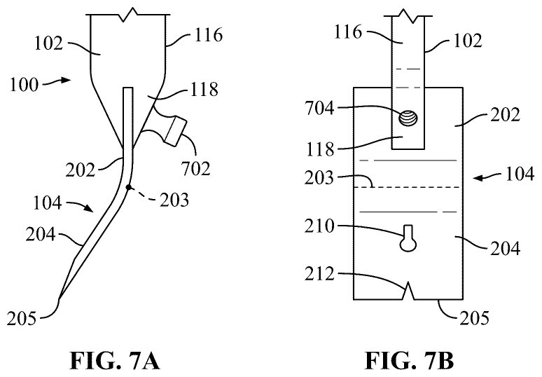

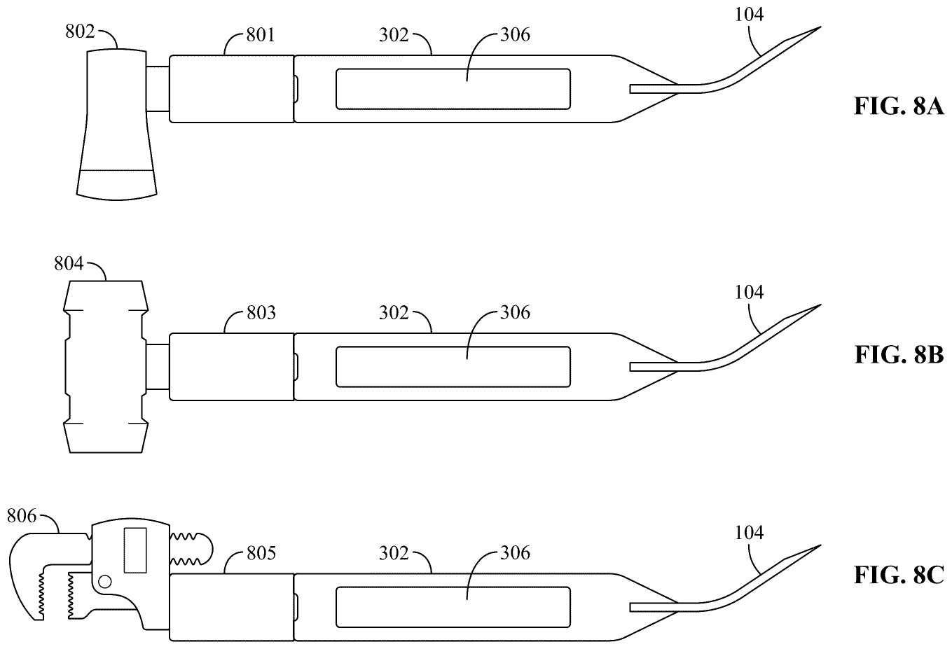

Referring now to the figures, a single-piece and multi-piece pry bar is disclosed. As shown in FIGS. 1A-B, the single-piece pry bar 100 may have a shaft 102 and a claw section 104, where the shaft 102 has a handle opening 106 and may be short enough to allow the single-piece pry bar 100 to fit in tight places. As shown in FIGS. 2A-D, the claw section 104 may have a curved body with a heel 203 and have a prying edge 205, V-shaped groove 212, and a keyhole slot 210 used for prying and disassembling objects. As shown in FIGS. 3A-D, a multi-piece pry bar 300 may have a rear portion 316 where different extension components, such as a transporting extension 304, may be attached to the pry bar. As shown in FIGS. 4A-B, a handle extension 402 may be attached to the multi-piece pry bar 300 that adds a second handle opening 406 and additional length for applying better leverage. As shown in FIGS. 5A-F, the handle openings 306, 406 of the multi-piece pry bar 300 may have different dimensions, shapes, and orientations that help the user better grip the pry bar. As shown in FIGS. 6A-B, an L-shaped bracket 600 may be incorporated with the single-piece pry bar 100 to allow the user to effectively apply force to the shaft 102 and even step on the pry bar. As shown in FIGS. 7A-B, a hammer head 702 may be attached the front shaft end 118 of the pry bar 100. As shown in FIGS. 8A-C, different extension components having different ends, such as an axe head 802, a sledgehammer head 804, and a wrench head 806, may be attached to the rear portion of the shaft 306 of the multi-piece pry bar 300 to create additional functionality for the pry bar.

Referring specifically now to FIG. 1A, a perspective view of an embodiment of a pry bar 100 that is one-piece is shown. The pry bar 100 may have a shaft 102 and a claw section 104 at one end of the shaft 102. The shaft 102 may be used as a leverage structure in applying force to the pry bar 100 to disassemble an object with the claw section 104. The shaft 102 may have a handle opening 106 (see FIG. 1B) to provide for better gripping and the protection of the hand of the user. The handle opening 106 may be designed to prevent the hand of the user from getting injured if too much force is applied to the pry bar 100 that causes the device to crash into a rigid surface, such as the ground or a wall. The claw section 104 may have a prying edge 205 (see FIG. 2B) to press between the object that is to be disassembled by the pry bar for prying. By way of example and not limitation, the claw section 104 may have one or more grooves and slots designed to pull out fasteners, such as a nail, and other stuck objects that need to be separated. By way of example and not limitation, the pry bar may be made from a steel, aluminum, or titanium alloy.

Referring now to FIG. 1B, a side view of the one-piece pry bar is shown. From this view, the different components of the shaft 102 of the pry bar 100 may be seen in detail. The shaft 102 may have a shaft body with a top side 114, a bottom side 116 opposite to the top side, a front shaft end 118 connected to the claw section 104, a rear shaft end 120 opposite to the front shaft end 118, and a first handle opening 106 extending longitudinally in between the front shaft end 118 and the rear shaft end 120. The shaft 102 may be in a form of a long rectangular rod (i.e. a flat bar). By way of example and not limitation, the length of the shaft 102 may be between 10 to 36 inches. The shaft 102 may be long enough to provide the needed leverage to pry and disassemble an object but short enough to allow the pry bar 100 to fit into tight places. The front shaft end 118 may be connected to the claw section 104. By way of example and not limitation, there may exist a hole 120 near the rear shaft end 120 to loop around a rope or a chain inside the hole 120 to assist in carrying the pry bar 100 or store the device for later use.

The shaft 102 may have a handle portion in a form of a handle opening 106 extending through the body of the shaft 102. The handle opening 106 may have a first transverse end proximate to the middle of the shaft and a second transverse end proximate to the rear shaft end 120, near the tying hole 108, the first transverse end also being closest to the front shaft end 118. By way of example and not limitation, the handle opening 106 may be rectangular, trapezoidal, or elliptical shaped. By way of example and not limitation, the handle opening 106 may be large enough for only one hand of the user to fit within and grip the shaft 102 since the pry bar 100 may be designed to be compact and fit into tight places. As such, and by way of example and not limitation, the handle opening 106 may have a handle length 110 between 3 to 6 inches. As described elsewhere herein with other embodiments, the handle opening 106 may alternatively be large enough for both hands of the user to fit inside and grip the shaft 102 of the pry bar 100. The handle opening 106 may be big enough for the hand of the user to fully wrap around the opening such that the fingers and the knuckles of the user may pass through the opening when gripping the shaft 102. As such, and by way of example and not limitation, the handle opening 106 may have a handle height 112 between 1 to 3.5 inches. By being able to grip the handle opening 106, the hand of the user may be protected from hitting a rigid surface, such as the ground or a wall, if too much force is applied to the pry bar 100 that causes the pry bar to crash into the rigid surface. The crash of the pry bar 100 with the rigid surface may occur because the applied force by the user may slip the pry bar 100 out or suddenly detach a component that the pry bar is disassembling. But the hand of the user would be protected if such crash would occur because the body of the shaft 102 surrounds the hand of the user who is gripping the handle opening 106.

FIGS. 2A-D show a close-up view of the claw section 104. From these views, the different components of the claw section 104 and the relation with the shaft 102 may be further seen in detail. As shown in FIG. 2A, the claw section 104 may have a larger width than the shaft 102. By way of example and not limitation, the claw width 206 may be between 1.5 to 4 times larger than the shaft width 208. The body of the claw section 104 may be curved having a heel 203 (See FIG. 2D) at the vertex of the curved body, the heel 203 being between a rear planar segment 202 and a front planar segment 204 of the claw section 104. The heel 203 may be considered as the outer surface of the curved section (see FIG. 2D), and the heel 203 may be located on the same side as the bottom side 116 (see FIG. 1B) of the shaft 102. The rear planar segment 202 may be connected to the front shaft end 118, and the front planar segment 204 may have a narrow front prying edge 205 (see FIG. 2B) designed to be pressed between the objects that are to be disassembled by the pry bar 100.

As shown in FIG. 2B, and by way of example and not limitation, the prying edge 205 may have a V-shaped groove 212 designed for a head of a fastener, such as a nail, to be placed in between the groove and for a downward force to be applied to the pry bar 100 to remove the fastener from an attached object. The curvature and the heel 203 (see FIG. 2D) of the claw section 104 may be the leverage structure that translates the downward force applied to the shaft 102 to an upward force causing on the front planar surface 204 and the V-shaped groove 212 to remove the fastener. As shown in FIG. 2C, and by way of example and not limitation, there may exist a keyhole slot 210 designed to remove a fastener by an upward force applied to the pry bar 100. The keyhole slot 210 may be between the prying edge 205 of the front planar segment 204 and the heel 203. The keyhole slot 210 may have a wide keyhole section 210a for the head of the fastener, such as a nail, to be placed within the slot. The keyhole slot 210 may have a narrow keyhole section 210b connected to the wide keyhole section 210a for the fastener to move in such section. The narrow keyhole section 210b may prevent the fastener head from slipping out of the keyhole slot 210. When the fastener head is placed in the narrow keyhole section 210b, an upward force may be applied to the shaft 102 of the pry bar 100 that removes the fastener from the attached object.

Referring now to FIG. 3A, a perspective view of a multi-piece pry bar 300 is shown. Similar to FIG. 1A, the multi-piece pry bar 300 may have a shaft 302 connected to a claw section 104. The shaft 302 may, however, have a larger handle opening 306 that may allow the user to fit two hands within the handle opening 306 to grip the shaft 302. An extension piece, such as a transporting extension 304, may be removably attached to the rear shaft portion. The extension piece may be a first extension piece and may be replaced with a second extension piece, such as a handle extension 402 (see FIG. 4A). The handle extension 402 may provide a second handle opening 406 and additional length for more leverage. Other extension components that serve different functions may also be attached to the rear portion of the shaft 302 of the multi-piece pry bar 300, as described elsewhere herein. By way of example and not limitation, the multi-piece pry bar 300, along with the extension components, may be made from a steel, aluminum, or titanium alloy. As shown in FIG. 3B, the multipiece pry bar 300 may have a similar claw section 104 as described elsewhere herein and be connected to the shaft 302 of the multipiece pry bar 300.

Referring now to FIG. 3C, a first side view of the multiple-piece pry bar 300 is shown. From this view, the different components of the shaft 302 of the pry bar 300 may be seen in detail. The shaft 302 may have a shaft body with a top side 303, a bottom side 305 opposite to the top side, a front shaft end 307 connected to the claw section 104, a rear shaft portion 316 (see FIG. 3D) opposite to the front shaft end 307, and a first handle opening 306 extending longitudinally in between the front shaft end 307 and the rear shaft portion 316. The shaft 302 may be in a form of a long rectangular rod (i.e. a flat bar). By way of example, the shaft length may be somewhat longer than the pry bar 100 of FIG. 1 to accommodate for a longer handle opening 306. By way of example and not limitation, the length of the shaft 302 may be between 11 to 38 inches.

The handle opening 306 may be an opening running in the middle of the body of the shaft 302 that is designed for a user to grip the shaft while protecting the hands of the user from getting injured in case of an unwanted motion of the pry bar 300. The handle opening 306 may have a first transverse end proximate to the front shaft end 307 and a second transverse end proximate to the rear shaft portion 316 (see FIG. 3D). By way of example and not limitation, the handle opening 306 may be rectangular, trapezoidal, or elliptical shaped. By way of example and not limitation, the handle opening 306 may have a handle length 312 that allows for both hands of the user to fit within the opening and use the handle opening 306 as a gripping structure. As a result, the user would have more leverage in using the multi-piece pry bar 300 since the user is gripping the shaft 302 with two hands. As such, and by way of example and not limitation, the handle opening 306 may have a handle length 312 between 6 to 12 inches. The handle opening 306 may be big enough for both hands of the user to fully wrap around the opening such that the fingers and the knuckles of the user may pass through the opening when gripping the shaft 302. As such, and by way of example and not limitation, the handle opening may have a handle height 310 between 1 to 3.5 inches.

The handle opening may have different shapes and be angled to provide additional leverage to the user when using the pry bar to disassemble a component, as described elsewhere herein. In addition to the added leverage and grip, if too much force is applied to the multi-piece pry bar 300 causing the pry bar to crash into a rigid surface, such as the ground or a wall, the hands of the user would be protected from hitting the rigid surface. The crash of the multi-piece pry bar 300 with the rigid surface may occur because the applied force may slip the pry bar out or suddenly detach a component that the pry bar is disassembling. But the hands of the user would be protected if such crash would occur because the body of the shaft 302 surrounds the hands of the user who is gripping the handle opening 306.

As shown in FIG. 3C-D, an extension component may be removably attached to the rear portion 316 of the shaft 302 of the multi-piece pry bar 300. By way of example and not limitation, a transporting extension 304 may be removably attached to the rear portion 316 of the shaft 302. The transporting extension 304 may have a circular hole 308 used to loop around a rope or chain to carry the multi-piece pry bar 300 or store the device for later use. With the transporting extension 304 attached to the rear portion 315 of the shaft 302, the multi-piece pry bar 300 may still be compact enough to fit inside tight places for prying and disassembling objects while also having the transportation capability.

By way of example and not limitation, the attachment and detachment of the extension components, such as the transporting extension 304, to the rear portion 316 of the shaft 302 may be done by a detent mechanism. One or more detents 314 (see FIG. 3D), such as two detents 314, may be located near the back end of the rear portion 316 of the shaft 302. The detents 314 may be locate on opposite sides of the shaft 302, more particularly on the top and bottom sides 303, 305 of the shaft 302 defining the rectangular height of the shaft 302. The extension component, such as the transportation extension 304, may have a slot 318 (see FIG. 3D) within its body configured to receive the rear portion 316 of the shaft 302. By way of example and not limitation, there may exist detent holes on opposite inner surfaces within the slot 318, which such surfaces would slide on top of the detents, to receive the detents 314 and lock the extension component with the shaft 302. Alternatively, the engagement between the detents 314 and the inner surfaces of the slot 318 may be in a form of a frictional detent mechanism.

By way of example and not limitation, the rear portion 316 of the shaft 302 may have a thinner width and smaller height than the rest of the shaft 302. Consequently, when the slot 318 of the extension component slides over to attach to the rear portion 316, the extension component would lay flush with the rest of the shaft 302 of the multi-piece pry bar 300. When fully attached (see FIG. 3C), the receiving end of the slot 318 of the extension component may contact the protruding tabs 320 of the shaft 302 (see FIG. 3D) situated between the rear portion 316 and the rest of the front portion of the shaft 302 body. Other attachment mechanisms between the extension component and the main shaft 302 of the multi-piece pry bar 300 are also contemplated herein, such as the usage of a threaded engagement, fasteners, or magnets between the two parts. Although the attachment and detachment of the extension component is described with respect to the transporting extension 304 in FIGS. 3C-D, such features may also apply to other extension components, described elsewhere herein, that are removably attachable to the rear portion 316 of the shaft 302 of the multi-piece pry bar 300.

By way of example and not limitation, there may exist a storage cavity 322 (see FIG. 3D) in the middle of the rear portion 316 of the shaft 302 that slides within the slot 318 of the extension component. As such, the extension component, such as the transporting extension 304, may serve an additional function as a lid for the storage cavity 322 of the rear portion 316 of the shaft 302. The storage cavity 322 may run along a majority of the length of the rear portion 316, have a storage floor for items to be stored to rest on, and be in the middle of the shaft 302 and in-line with the handle opening 306. Small components used during construction and demolition, such as fasteners and tape, may be stored in the storage cavity 322.

Referring now to FIGS. 4A-B, a handle extension 402 is shown removably attached to the rear portion 316 of the shaft 302. The handle extension 402 may have a second handle opening 406. The handle extension 402 may have an extension body with a top side 403, a bottom side 405 opposite to the top side, a front extension end 407 having a slot opening 418, a rear extension portion 409 opposite to the front shaft end 407, and a second handle opening 406 extending longitudinally in between the front extension end 407 and the rear extension portion 409. By way of example and not limitation, the handle extension 402 may have a slot within its body in front of the second handle opening 406, and a slot opening 418 proximate to the front extension end 407, to slide over the rear portion 316 of the shaft 302 and be removably attached similar to what has been described elsewhere herein. In addition to the second handle opening 406, the handle extension 402 may have a tying hole 408 at the rear extension portion 409 having similar function as the other tying holes described elsewhere herein. The handle extension 402 may be in the form of a long rectangular rod (i.e. a flat bar). By way of example, the handle extension length may be between 10 to 38 inches. The additional length that the handle extension 402 adds to the multi-piece pry bar 300 may help increase the leverage the user can apply to the claw section 104 in prying an object. The added length provided by the handle extension 402 would increase the torque the user may provide to the prying edge of the claw section 104 when the user grips the second handle opening 406. Because the handle extension 402 is removably attachable to the shaft 302, the multi-piece pry bar 300 may also be disassembled and be stored in a smaller space when compared to if the handle extension 402 was one-piece with the rest of the pry bar.

The handle extension 402 may have a second handle opening 406 running in the middle of the body of the handle extension that is designed for a user to grip the handle extension 402 for leverage while protecting the hands of the user from getting injured in case of an unwanted motion of the pry bar. The second handle opening 406 may also protect the hands of the user similar to what has been described elsewhere herein with respect to the first handle opening 306. As shown in FIG. 4A, the second handle opening 406 may have a first transverse end proximate to the front extension end 407 and a second transverse end proximate to the rear extension portion 409. By way of example and not limitation, the second handle opening 406 may be rectangular, trapezoidal, or elliptical shaped.

The second handle opening 406 may have a handle length that allows for both hands of the user to fit within the opening and to use the handle opening as a gripping structure. Consequently, the user may have more leverage in using the multi-piece pry bar 300 since the user is gripping the handle extension 402 with two hands. As such, and by way of example and not limitation, the opening of the second handle opening 406 may have a handle length 412 (see FIG. 4A) between 6 to 12 inches. The second handle opening may be big enough for both hands of the user to fully wrap around the opening such that the fingers and the knuckles of the user may pass through the opening when gripping the handle extension 402. As such, and by way of example and not limitation, the second handle opening 406 may have a handle height 410 between 1 to 3.5 inches. As described elsewhere herein, the second handle opening 406 may have different shapes and be at different angles to provide different leverage surfaces to the user when using the multi-piece pry bar 300 to disassemble a component. Alternatively, the two-piece pry bar shown in FIG. 4B may be one long piece with the handle extension 402 and the second handle opening 406 being part of the same unitary body of the shaft 302 and the handle opening 306.

Referring now to FIG. 5A, a side view of the multiple-piece pry bar 300 with the handle openings at a first incline is shown. Instead of spanning parallel to the body, the first and second handle openings 306, 406 may span lengthwise at a first incline between the top and bottom sides of the multi-piece pry bar. By way of example and not limitation, the first and second handle openings 306, 406 may be rectangular.

By way of example and not limitation, the first handle opening 306 may have longitudinal sides, with a longitudinal length, that incline downwards from the first transverse side 502a of the first handle opening 306, which is closest to the claw section 104, towards the second transverse side 502b of the first handle opening 306, which is closest to the rear shaft portion 316 (see FIG. 4A) and the protruding tabs 320. Because of the first handle opening 306 inclining downwards as described, the thickness profile 503a of the shaft body between the top longitudinal side of the first handle opening 306 and the top side 303 of the shaft 302 may increase gradually from the first transverse side 502a to the second transverse side 502b. The top side 303 of the shaft 302 of the multi-piece pry bar 300 may be the side opposite to the heel portion 203 of the claw section 104 and on the same side as the inside curvature surface of the claw section 104. The thickness profile 503a of the first handle opening 306 shown in FIG. 5A may allow the user to better grip the first handle opening 306 around the top side 303 of the shaft 302 and increases the leverage that the pry bar can provide to the prying edge 205, the V-groove 212, and keyhole slot 210 of the claw section 104 that are shown in FIGS. 2A-D.

As shown in FIG. 5A, the second handle opening 406 on the handle extension 402 may be angled similarly as the first handle opening 306 of the shaft 302. Mainly, the second handle opening 406 may have longitudinal sides, with a longitudinal length, that incline downwards from the first transverse side 504a of the second handle opening 406, which is closest to the opening of the slot 418, towards the second transverse side 504b of the second handle opening 406, which is closest to the rear extension portion 409 (see FIG. 4A) of the handle extension 402 and the tying hole 408. Because of the second handle opening 406 inclining downwards as described, a thickness profile 503b of the extension body between the top longitudinal side of the second handle opening 406 and the top side 403 of the handle extension 402 may increase gradually from the first transverse side 504a to the second transverse side 504b of the second handle opening 406. The top side 403 of the handle extension 402 may be on the same side as the top side 303 of the shaft 302 (i.e., the side opposite to the heel portion 203 of the claw section 104 and on the same side as the inside of the curvature of the claw section 104). The thickness profile 503b of the handle extension 402 shown in FIG. 5A may allow for the user to better grip the second handle opening 406 around the top side 403 of the handle extension 402 and increase the leverage that the pry bar can provide to the prying edge 205, the V-groove 212, and keyhole slot 210 of the claw section 104 that are shown in FIGS. 2A-D.

Referring now to FIG. 5B, a side view of the multiple-piece pry bar 300 with the handle openings at a second incline is shown. Instead of spanning parallel to the body, the first and second handle openings 306, 406 may span lengthwise at a second incline between the top and bottom sides of the multi-piece pry bar. By way of example and not limitation, the first and second handle openings 306, 406 may be rectangular.

By way of example and not limitation, the first handle opening 306 may have longitudinal sides, with a longitudinal length, that incline upwards from the first transverse side 502a of the first handle opening 306, which is closest to the claw section 104, towards the second transverse side 502b of the first handle opening 306, which is closest to the rear shaft portion 316 (see FIG. 4A) and the protruding tabs 320. Because of the first handle opening 306 inclining upwards as described, the thickness profile 505a of the shaft body between the bottom longitudinal side of the first handle opening 306 and the bottom side 305 of the shaft 302 may increase gradually from the first transverse side 502a to the second transverse side 502b. The bottom side 305 of the shaft 302 of the multi-piece pry bar 300 may be on the same side to the heel portion 203 of the claw section 104 and on the same side as the outside curvature surface of the claw section 104. The thickness profile 505a of the first handle opening 306 shown in FIG. 5B may allow the user to better grip the first handle opening 306 around the bottom side 305 of the shaft 302 and increases the leverage that the pry bar can provide to the prying edge 205, the V-groove 212, and keyhole slot 210 of the claw section 104 that are shown in FIGS. 2A-D.

As shown in FIG. 5B, the second handle opening 406 on the handle extension 402 may be angled similarly as the first handle opening 306 of the shaft 302. Mainly, the second handle opening 406 may have longitudinal sides, with a longitudinal length, that incline upwards from the first transverse side 504a of the second handle opening 406, which is closest to the opening of the slot 418, towards the second transverse side 504b of the second handle opening 406, which is closest to the rear extension portion 409 (see FIG. 4A) of the handle extension 402 and the tying hole 408. Because of the second handle opening 406 inclining upwards as described, a thickness profile 505b of the extension body between the bottom longitudinal side of the second handle opening 406 and the bottom side 405 of the handle extension 402 may increase gradually from the first transverse side 504a to the second transverse side 504b of the second handle opening 406. The bottom side 405 of the handle extension 402 may be on the same side as the bottom side 305 of the shaft 302 (i.e., the same side as the heel portion 203 of the claw section 104 and on the same side as the outside surface of the curvature of the claw section 104). The thickness profile 505b of the handle extension 402 shown in FIG. 5B may allow for the user to better grip the second handle opening 406 around the bottom side 405 of the handle extension 402 and increase the leverage that the pry bar can provide to the prying edge 205, the V-groove 212, and keyhole slot 210 of the claw section 104 that are shown in FIGS. 2A-D.

Referring now to FIGS. 5C-D, a side view of the multiple-piece pry bar 300 with the handle openings having a trapezoidal shape is shown. The trapezoidal shape may naturally angle the longitudinal sides of the first and second handle openings 306, 406 to create changes in thickness profiles between the handle openings and the top and bottom sides of the pry bar.

By way of example and not limitation, and as shown in FIG. 5C, the first handle opening 306 may be trapezoidal such that the top and bottom longitudinal sides of the opening incline from the first transverse side 502a to the second transvers side 502b of the first handle opening 306 in a way that the first transverse side 502a has a longer height than the second transverse side 502b. This may be because the top longitudinal side of the opening inclines downwards towards the second transverse side 502b and the bottom longitudinal side of the opening inclines upwards towards the second transverse side 502b. Because of the first handle opening 306 being trapezoidal as described, there may exist a change in thickness profile 507a between the top longitudinal side of the first handle opening 306 and the top side 303 of the shaft 302, the change in thickness profile 507a increasing from the first transverse side 502a to the second transverse side 502b of the first handle opening 306. Additionally, there may exist a change in thickness profile 507a between the bottom longitudinal side of the first handle opening 306 and the bottom side 305 of the shaft 302, the change in thickness profile 507a increasing from the first transverse side 502a to the second transverse side 502b. Such change in thickness profiles may allow for the user to better grip the first handle opening 306 around either the top or bottom side 303, 305 of the shaft 302 and increase the leverage that the pry bar can provide to the prying edge 205, the V-groove 212, and keyhole slot 210 of the claw section 104 that are shown in FIGS. 2A-D.

By way of example and not limitation, and as shown in FIG. 5C, the second handle opening 406 may be trapezoidal such that the top and bottom longitudinal sides of the opening incline from the first transverse side 504a to the second transvers side 504b of the second handle opening 406 in a way that the first transverse side 504a has a longer height than the second transverse side 504b. This may be because the top longitudinal side of the opening inclines downwards towards the second transverse side 504b and the bottom longitudinal side of the opening inclines upwards towards the second transverse side 504b. Because of the second handle opening 406 being trapezoidal as described, there may exist a change in thickness profile 507b between the top longitudinal side of the second handle opening 406 and the top side 403 of the handle extension 402, the change in thickness profile 507b increasing from the first transverse side 504a to the second transverse side 504b. Additionally, there may exist a change in thickness profile 507b between the bottom longitudinal side of the second handle opening 406 and the bottom side 405 of the handle extension 402, the change in thickness profile 507b increasing from the first transverse side 504a to the second transverse side 504b. Such change in thickness profiles may allow for the user to better grip the second handle opening 406 around either the top or bottom side 403, 405 of the handle extension 402 and increase the leverage that the pry bar can provide to the prying edge 205, the V-groove 212, and keyhole slot 210 of the claw section 104 that are shown in FIGS. 2A-D.

By way of example and not limitation, and as shown in FIG. 5D, the first handle opening 306 may be trapezoidal such that the top and bottom longitudinal sides of the opening incline from the first transverse side 502a to the second transvers side 502b of the first handle opening 306 in a way that the first transverse side 502a has a shorter height than the second transverse side 502b. This may be because the top longitudinal side of the opening inclines upwards towards the second transverse side 502b and the bottom longitudinal side of the opening inclines downwards towards the second transverse side 502b. Because of the first handle opening 306 being trapezoidal as described, there may exist a change in thickness profile 509a between the top longitudinal side of the first handle opening 306 and the top side 303 of the shaft 302, the change in thickness profile 509a decreasing from the first transverse side 502a to the second transverse side 502b of the first handle opening 306. Additionally, there may exist a change in thickness profile 509a between the bottom longitudinal side of the first handle opening 306 and the bottom side 305 of the shaft 302, the change in thickness profile 509a decreasing from the first transverse side 502a to the second transverse side 502b. Such change in thickness profiles may allow for the user to better grip the first handle opening 306 around either the top or bottom side 303, 305 of the shaft 302 and increase the leverage that the pry bar can provide to the prying edge 205, the V-groove 212, and keyhole slot 210 of the claw section 104 that are shown in FIGS. 2A-D.

By way of example and not limitation, and as shown in FIG. 5D, the second handle opening 406 may be trapezoidal such that the top and bottom longitudinal sides of the opening incline from the first transverse side 504a to the second transvers side 504b of the second handle opening 406 in a way that the first transverse side 504a has a shorter height than the second transverse side 504b. This may be because the top longitudinal side of the opening inclines upwards towards the second transverse side 504b and the bottom longitudinal side of the opening inclines downwards towards the second transverse side 504b. Because of the second handle opening 406 being trapezoidal as described, there may exist a change in thickness profile 509b between the top longitudinal side of the second handle opening 406 and the top side 403 of the handle extension 402, the change in thickness profile 509b decreasing from the first transverse side 504a to the second transverse side 504b. Additionally, there may exist a change in thickness profile 509b between the bottom longitudinal side of the second handle opening 406 and the bottom side 405 of the handle extension 402, the change in thickness profile 509b decreasing from the first transverse side 504a to the second transverse side 504b. Such change in thickness profiles may allow for the user to better grip the second handle opening 406 around either the top or bottom side 403, 405 of the handle extension 402 and increase the leverage that the pry bar can provide to the prying edge 205, the V-groove 212, and keyhole slot 210 of the claw section 104 that are shown in FIGS. 2A-D.

With reference to FIGS. 5E-F, the first handle opening 306 of the shaft 302 of the pry bar 300 and the second handle opening 406 of the handle extension 402 may each having a plurality of finger grooves 506 to help the user grip the pry bar and apply leverage. As shown in FIG. 5E, the plurality of finger grooves 506 may span on the longitudinal length of the handle openings 306, 406 on the top longitudinal side of the openings proximate to the top sides 303, 403 of the shaft 302 and the handle extension 402, respectively. As shown in FIG. 5F, in addition to the plurality of finger grooves 506 proximate to the top side of the multi-piece pry bar, a second set of plurality of finger grooves 506 may span on the longitudinal length of the handle openings 306, 406 on the bottom longitudinal sides of the openings proximate to the bottom sides 305, 405 of the shaft 302 and the handle extension 402, respectively. By way of example and not limitation, the plurality of finger grooves 506 may span the middle portion of the longitudinal sides of the handle openings 306, 406, or the left or right portions of the longitudinal sides of the handle openings 306, 406. By way of example and not limitation, the plurality of finger grooves 506 may span the whole length of the handle openings 306, 406. By way of example and not limitation, the plurality of finger grooves 506 may be incorporated to the handle openings 306, 406 in conjunction with the inclining and trapezoidal shape of such openings shown in FIGS. 5A-D.

With reference to FIGS. 6A-B, an L-shaped bracket 600 may be incorporated with the shaft of the pry bar 100 that may be either the single-piece or the multi-piece pry bar. The L-shaped bracket 600 may provide a more optimum leverage surface and a surface for a user to step on the pry bar 100 to apply the force of the user's weight. The L-shaped bracket 600 may be integrated (see FIG. 6A) or removably attached (see FIG. 6B) to the top side 114 of the pry bar 100, which the top side 114 may be opposite to the heel section 203 and on the same side as the inside surface of the curve of the claw section 104. The L-shaped bracket 600 may have a horizontal leg 602 substantially parallel to the prying edge 205 of the claw section 104. The L-shaped bracket 600 may also have a vertical leg 604 perpendicular to the horizontal leg 602 and in a substantially perpendicular orientation to the prying edge 205 of the claw section 104. The ends of the horizontal leg 602 and the vertical leg 604 may be attached to a top side 114 portion of the shaft 102, which such shaft portion would be angled relative to the L-shaped bracket 600 and make up the hypotenuse of the right triangle shape formed between the L-shaped bracket 600 and the portion of the shaft 102. With the attached or integrated L-shaped bracket 600, a user may provide a downward force on the horizontal leg 602 that gets translated to the claw section 104 and the prying edge 205 more efficiently. Additionally, the horizontal leg 602 may allow for the user to step on the pry bar 100 and apply the body weight of the user on a stable foundation created by the horizontal and vertical leg 602, 604. The downward step force by the user may be much greater than the force that the user may apply to the pry bar by hand.

With reference to FIGS. 7A-B, the incorporation of a hammer head 702 with the front shaft end 118 of the pry bar 100 is shown. The hammer head 702 may be incorporated with the single-piece or multiple-piece pry bar. By way of example and not limitation, and as shown in FIG. 7B, the bottom side 116 of the pry bar 100 at the front shaft end 118 of the shaft 102 may have a threaded hole 704 to screw in a hammer head 702. By way of example and not limitation, the threaded hole 704 may be used to attach other heads, such as an axe head. Alternatively, the hammer head 702 may be integrated with the front shaft end 118 instead of having to be attached to the shaft 102. Consequently, the pry bar 100 may be used to hammer in different objects, such as a nail in addition to the prying function.

With reference to FIGS. 8A-C, the multi-piece pry bar 300 with different extension components having ends with various structural components for serving different functions is shown. As a result, the front of the multi-piece pry bar 300 may serve the function of prying an object while the rear end of the multi-piece pry bar 300 may serve a wholly different function, such as providing an axing, hammering, or wrenching function. Such extension components may be attached to the shaft of the multi-piece pry bar 300 similar to what has been described elsewhere herein with other extension components.

Specifically, FIG. 8A shows an axe extension 801 removably attached to the rear shaft portion 316 (see FIG. 3D) at the rear end of the shaft 302 of the pry bar. The axe extension 801 may have an axe head 802 on the rear end of the extension facing opposite to the claw section 104 of the multi-piece pry bar 300. Additionally, FIG. 8B shows a sledgehammer extension 803 removably attached to the rear shaft portion 316 (see FIG. 3D) at the rear end of the shaft 302. The sledgehammer extension 803 may have a sledgehammer head 804 on the rear end of the extension facing opposite to the claw section 104 of the multi-piece pry bar 300. Furthermore, FIG. 8C shows a wrench extension 805 removably attached to the rear shaft portion 316 (see FIG. 3D) at the rear end of the shaft 302. The wrench extension 805 may have a wrench head 806 on the rear end of the extension facing opposite to the claw section 104 of the multi-piece pry bar 300. By way of example and not limitation, the wrench head 806 may be in the form of a pipe wrench, adjustable wrench, combination wrench, or socket wrench, to name a few examples.

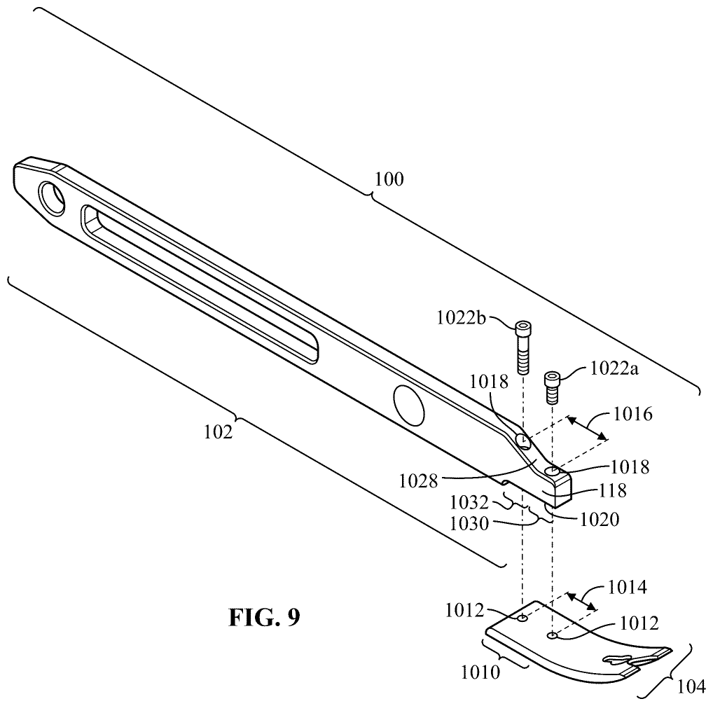

Referring now to FIG. 9, the bar 100 may have a claw section 104 that is removably attachable to the shaft 102. One of a plurality of different types of claw sections 104 may be removably attachable to the shaft 102. By way of example and not limitation, the claw section 104 may be a demolition style foot, nail puller style foot, flat pry style foot, gooseneck style foot, wrenching bar style foot, or adjustable pry style foot. The claw section may have a base portion 1010. The base portion 1010 may have one or more threaded holes 1012. A distance 1014 between the threaded holes 1012 may be equal to a distance 1016 between two through holes 1018. The bottom side of the shaft 102 may have a recess 1020. The recess 1020 may receive the base portion 1010 of the claw section 104. The threaded holes 1012 are aligned to the threaded holes 1018. Upon alignment, threaded bolts 1022 may be inserted into the through holes 1018 and threaded onto the threaded holes 1012 of the base portion 1010 of the claw section 104. This attaches the claw section 104 to the shaft. To remove the claw section 104 from the shaft 102, the bolts 1022 are removed. A different type of claw section 104 may be attached to the shaft 102 by forming the threaded holes 1012 on the other claw sections 104 to be attached to the shaft 102.

The bar 100 shown in FIG. 9 may be made from steel and aluminum. By way of example, the shaft 102 may be fabricated from lighter materials compared to the claws such as aluminum, fiberglass, plastic, aluminum, wood and the more durable and stronger materials such as carbon steel, alloy steel, and titanium. The claw section 104 may be fabricated from materials such as carbon steel, alloy steel, hardened steel, steel, stainless steel, carbon steel, or titanium. In this manner, the shaft 102 may be fabricated from materials that are lighter, while the claw section 104 may be fabricated from materials that are stronger but may be heavier so that the total weight of the prybar is kept at a reasonable weight but yet provides a prybar for heavy duty jobs.

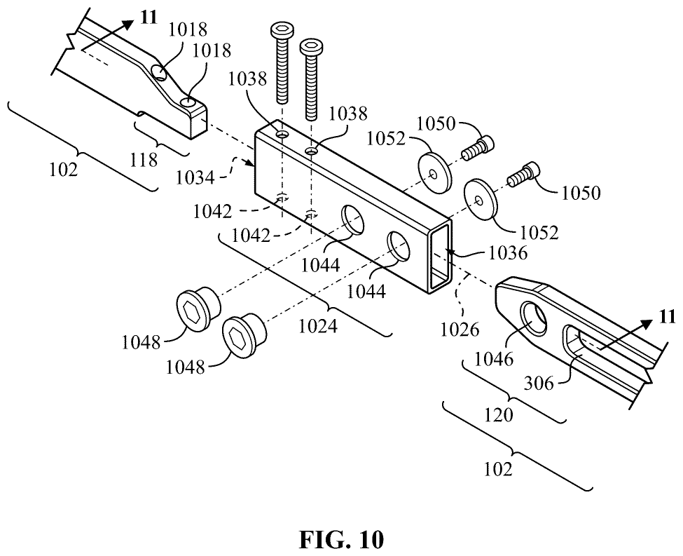

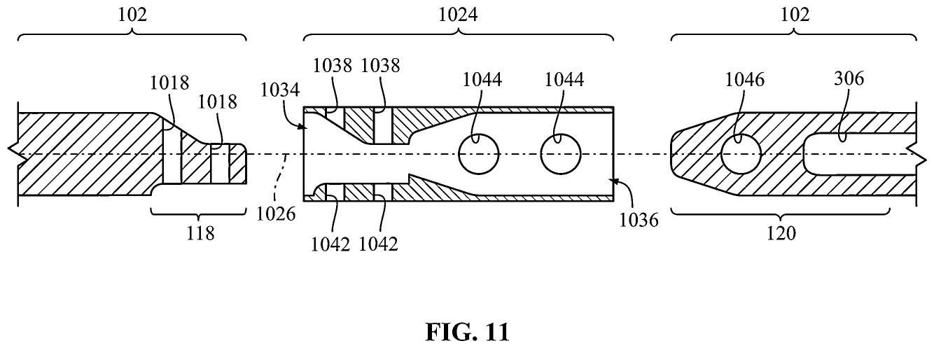

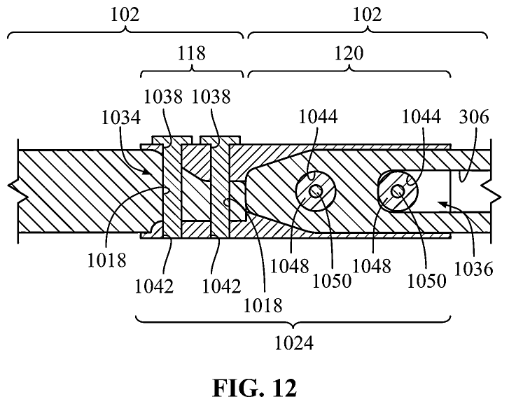

Referring now to FIGS. 10-12, a sleeve 1024 is shown for extending an overall length of the bar 100. The sleeve 1024 may be used to secure two shafts 102 to each other along their central axis 1026.

The front shaft end 118 may have a curved upper surface 1028. The curved upper surface 1028 may provide additional strength to the pry bar 100. The pry bar 100 may be fabricated entirely from the same material as shown in FIGS. 1-8C. However, as shown in FIG. 9, the bar 100 may be fabricated from two different types of materials. When the bar 100 is fabricated from two types of material as discussed in FIG. 9, the bar 100 is less strong compared to a bar 100 that is fabricated from steel for the configuration shown in FIGS. 1-8C. However, the curved upper surface 1028 makes the bar 104 stronger. By way of example and not limitation, the front threaded bolt 1022a is shorter than the rear threaded bolt 1022b. Moreover, the distal end portion 1030 of the front shaft end 118 is shorter than the middle portion 1032. This configuration provides extra strength to allow the shaft 102 to be fabricated from aluminum while the claw section 104 is fabricated from a harder material such as steel.

Referring to FIG. 10-12, two or more shafts 102 may be connected to each other yet allow the user to push down on a proximal shaft 102 and let a claw section 104 attached to the distal shaft 102 to pull out a nail, separate wood planks attached to each other and exert the necessary high amount of leverage needed in the construction field. Two shafts 102 may be attached to each other with the connecting sleeve 1024. The connective sleeve 1024 may have a a first recess 1034 and a second recess 1036. The first recess 1034 is sized and configured to match a size and configuration of the front end shaft 118 of the shaft 102. The second recess 1036 is sized and configured to match a size and configuration of the rear shaft end 120. The match is sufficiently close so that there is no wiggle between the sleeve 1024 and the proximal and distal shafts 102. To attach the front end shaft 118 of a proximal shaft 102 to the connective sleeve 1024, the front end shaft 118 is inserted into the recess 1034. Upon insertion, the two through holes 1018 are aligned to two through holes 1038. Threaded bolts 1040 are inserted through the through holes 1038 and the through holes 1018 and threadingly attached to the threaded holes 1042. When tightened, the front end shaft 118 of the proximal shaft 102 is secured to the sleeve 104.

To attach the rear end shaft 120 of the shaft 104 to the sleeve 104, rear end shaft 120 of the distal shaft 102 is inserted into the recess 1036. Upon insertion, the two through holes 1044 are aligned to the through hole 1046 and the slot 306. Upon insertion, there is no play between the distal shaft 102 and the sleeve 1024. Plugs 1048 are inserted through the through holes 1046, 1044, 306. On the other side are threaded bolts with a washer 1052. The threaded bolts 1050 are threaded onto the side of the plugs 1048 which are not shown in the drawings. The threaded bolts 1050 are tightened. Upon tightening of the bolts 1050 to the plugs 1048, the rear end shaft 120 is securely attached to the sleeve 1022 and the proximal shaft 102. A selected type of claw section 104 can be attached to the front shaft end 118.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A multi-piece pry bar, comprising:
a singular pry bar piece having a shaft connected to a claw section;
the shaft having a shaft body with a top side, a bottom side opposite to the top side, a front shaft end connected to the claw section, a rear shaft portion with an interlocking mechanism, and a first handle opening extending longitudinally in between the front shaft end and the rear shaft portion;
the claw section having a curved body with a rear planar segment connected to the front shaft end, a front planar segment having a prying edge, and a curved segment between the rear planar segment and the front planar segment, the curved segment having an outer curved surface making up a heel of the claw section, the heel being on a same side as the bottom side of the shaft body; and
a handle extension piece removably attachable to the rear shaft portion of the singular pry bar piece via the interlocking mechanism, the handle extension piece having an extension body with an upper side that connects with the top side of the shaft body, a lower side that connects with the bottom side of the shaft body, a front extension end configured to be attached to the rear shaft portion, a rear extension portion, and a second handle opening extending longitudinally in between the front extension end and the rear extension portion.

2. The multi-piece pry bar of claim 1, wherein the prying edge of the claw section has a V-shaped groove.

3. The multi-piece pry bar of claim 2, wherein the front planar segment of the claw section has a keyhole slot.

4. The multi-piece pry bar of claim 1, wherein the shaft has a first width and the claw section has a second width, the second width being at least 1.5 times greater than the first width.

5. The multi-piece pry bar of claim 1, wherein the first handle opening and the second handle opening are each large enough to be gripped by two hands.

6. The multi-piece pry bar of claim 1, further comprising at least one of a hammer extension piece, an axe extension piece, or a wrench extension piece that are removably attachable to the rear shaft portion of the singular pry bar piece via the interlocking mechanism.

7. The multi-piece pry bar of claim 1, wherein the interlocking mechanism is a detent mechanism.

8. The multi-piece pry bar of claim 1, wherein the first handle opening has a first longitudinal length between a first side near the claw section and a second side near the rear shaft portion, the first longitudinal length inclining downwards from the first side towards the second side.

9. The multi-piece pry bar of claim 8, wherein the second handle opening has a second longitudinal length between a third side near the front extension end and a fourth side near the rear extension portion, the second longitudinal length inclining downwards from the third side towards the fourth side.

10. The multi-piece pry bar of claim 1, wherein the first handle opening has a first longitudinal length between a first side near the claw section and a second side near the rear shaft portion, the first longitudinal length inclining upwards from the first side towards the second side.

11. The multi-piece pry bar of claim 10, wherein the second handle opening has a second longitudinal length between a third side near the front extension end and a fourth side near the rear extension portion, the second longitudinal length inclining upwards from the third side towards the fourth side.

12. The multi-piece pry bar of claim 1, wherein the first and second handle openings each have a plurality of finger gripping grooves.

13. The multi-piece pry bar of claim 1, wherein the first and second handle opening are trapezoidal shaped.

14. The multi-piece pry bar of claim 1, further comprising a tying hole near the rear extension portion of the handle extension piece.

15. A pry bar, comprising:
a shaft having a shaft body with a top side, a bottom side opposite to the top side, a front shaft end, a rear shaft portion, and a first handle opening extending longitudinally in between the front shaft end and the rear shaft portion; and
a claw section having a curved body with a rear planar segment connected to the front shaft end, a front planar segment having a prying edge, and a curved segment between the rear planar segment and the front planar segment, the curved segment having an outer curved surface making up a heel of the claw section, the heel being on a same side as the bottom side of the shaft body.

16. The pry bar of claim 15, wherein an L-shaped bracket is attachable to the top side of the shaft.

17. The pry bar of claim 15, wherein an L-shaped bracket is integrated to the top side of the shaft.

18. The pry bar of claim 15, wherein a portion of the bottom side of the shaft near the front shaft end has a threaded hole for a hammer head to be attached to the pry bar.

19. The pry bar of claim 15, wherein the first handle opening is only large enough to be gripped by one hand.

20. The pry bar of claim 15, wherein the shaft has a tying hole proximate to the rear shaft portion.
